(19) United States
(12) Patent Application Publication
(10) Pub. No.: US 2023/0357027 A1
(43) Pub. Date: Nov. 9, 2023

(54) NANO-SILICON PARTICLES/WIRE PRODUCTION BY ARC FURNACE FOR RECHARGEABLE BATTERIES

(71) Applicant: HPQ NANO SILICON POWDERS INC., Montreal (CA)

(72) Inventors: Milad MARDAN, Saint-Laurent (CA); Ali SHAHVERDI, Verdun (CA); Pierre CARABIN, Montreal (CA)

(21) Appl. No.: 17/768,156

(22) PCT Filed: Oct. 9, 2020
(86) PCT No.: PCT/CA2020/000117

§ 371 Date: Apr. 11, 2022

Related U.S. Application Data
(60) Provisional application No. 62/913,152, filed on Oct. 9, 2019.

(51) Int. Cl. C01B 33/021

(52) U.S. Cl. CPC C01B 33/021; H01M 4/1395

(57) ABSTRACT

A process and an apparatus using pure silicon as raw material with no other pre- processed material for producing nano-Silicon and/or nano-Silicon-carbon coated composite material in the form of particles, nanowires or a combination of both, for use in a high capacity and high energy efficiency manufacturing of anodes for Lithium-ion batteries. The apparatus comprises a reactor including at least one electrode and adapted to provide at least one arc, e.g. a DC transferred arc, for melting and vaporizing silicon provided in the reactor. A quenching system is provided for delivering a gas for quenching, in the reactor, the so-produced silicon vapour so as to form nano particles and/or nano wires. The reactor is under vacuum. The gas can be injected by a vortex and/or via the electrode that is hollow. The electrode is consumable and vertically movable to control an arc voltage and to compensate for electrode erosion.

### CROSS REFERENCE TO RELATED APPLICATIONS

This Application claims priority on U.S. Provisional Application No. 62/913,152, now pending, filed on Oct. 9, 2019, which is herein incorporated by reference.

### FIELD

The present subject matter relates to the production of nano-Silicon and/or nano-Silicon-carbon composites, particularly for use as a raw material in the manufacturing of lithium-ion batteries.

### BACKGROUND

Using silicon in forms of nanoparticles, nanowires or porous nano-Silicon as the anode material in lithium-ion (Li-ion) batteries have been extensively investigated in recent years. Compared to graphite, which is used commercially as the anode material, the specific capacity of silicon is 10 times more than that of graphite (3800-4000 and ≈380 mAh/g for Si and graphite, respectively). Nevertheless, implementing silicon in Li-ion batteries is still challenging due to the nature of silicon and its resultant reaction with lithium ions.

One of the challenges for producing higher performance lithium-ion batteries is to use nano-Silicon powder as the anode material [References 1 to 3]. In the lithiation process, crystalline silicon (c-Si) transforms to amorphous LiₓSi and then to crystalline Li₁₅Si₄ upon full lithiation. During the lithiation, the Si anode undergoes large volume change (up to 280-400%) leading to degradation of anode and battery capacity drop-off. The reason behind this degradation is the formation of LiₓSi (x ≈ 3.75) phase [References 4 to 6] once the voltage falls between 50-70 mV during lithiation [Reference 7]. The stress and strain fields created by the volume change result in silicon particle cracking or breaking down, thereby shortening the life of battery.

According to literature [References 4, 6 and 8], the mechanical buffering is a promising solution to overcome the problem of volume change. This technique is to cover the nano-Silicon particle with an active shell, such as graphite or carbon, to make silicon-carbon composites. The carbon-coated form of nano-Silicon has shown to be a potential candidate to overcome the limits of using silicon as electrode in lithium-ion batteries manufacturing. The silicon-carbon composite particles provide higher capacity and coulombic efficiency. The coating carbon layer serves as a buffer to resist stress/strain field, to increase the fracture toughness of the pristine material and essentially to prohibit the LiₓSi phase formation. The solid-electrolyte interface (SEI) also is a critical factor in lithium-ion battery capacity performance. The particle cracking results in more SEI and consequently more inactive surface.

U.S. Patent Publication No. 2019/0016601 A1 [Reference 9], which was published to Lyubina on Jan. 17, 2019, reported that nano-Silicon-carbon coated particles used as the anode show higher capacity during lithiation/delithiation cycling. Principally by chemical vapor deposition (CVD) method by introducing the silicon as a compound of SiH₄ and a hydrocarbon (CHₓ) as the carbon precursor into a RF plasma and quenching particles, nano-Silicon-carbon composites have been produced. In this Publication, carbon is distributed through the silicon particles with the highest amorphous carbon concentration at the outer layer. It is believed that amorphous carbon as a shell around silicon particles reduces the formation of SEI [References 10-13]. Higher carbon concentration on the silicon-carbon composite is more advantageous since it prohibits excessive SEI formation.

U.S. Pat. No. 9,379,381 B2 [Reference 8], which issued to Yang et al. on Jun. 28, 2016, also described a mechanochemical process to obtain carbon-silicon composite particles. The process comprises a reaction between SiCl₄ and Li₁₃Si₄ under ball milling, powder post-treatment and carbon coating by CVD.

Particles size control is another factor to control silicon-anode cracking and pulverization. Liu et al. [Reference 6] and M. T. McDowell et al. [Reference 14] reported no cracking occurrence of the full lithiated silicon particles with a diameter under 150 nm by in-situ TEM observations. It is shown that smaller particles facilitate Li-ions transport and strain relaxation generated by volume expansion. In the case of nanowires, Ryu et al. [Reference 15] reported a threshold size of 300 nm in diameter below which no cracks occur.

Currently, most of the above-mentioned known production techniques are chemical/electrochemical processes or CVD processes in which the silicon raw material is introduced in the process as a compound [References 8, 9 and 16] or using toxic materials [Reference 17].

Therefore, it would be desirable to provide a system for producing nano-Silicon and/or nano-Silicon-carbon coated composites or nano-wire-carbon coated composites for rechargeable batteries manufacturing with higher production rates and better energy efficiency.

### SUMMARY

It would thus be desirable to provide a novel system for the production of nano-Silicon and/or nano-Silicon-carbon composites.

The embodiments described herein provide in one aspect a process for producing pure nano-Silicon or nano-Silicon-carbon coated composites, comprising:
a) using one or more DC transferred arc for melting and vaporizing silicon; and
b) providing a quenching system.

Also, the embodiments described herein provide in another aspect a process, wherein an induction coil is provided to directly preheat and melt the silicon or to indirectly pre-heat and melt the silicon by induction heating of a crucible, with the vaporization being achieved primarily by the arc.

Furthermore, the embodiments described herein provide in another aspect a process, wherein the quenching system includes an internal quenching system, such as a vortex and/or a hallow electrode (argon only or mix of argon-hydrocarbon).

Furthermore, the embodiments described herein provide in another aspect a process, wherein the quenching system includes an external quenching system, such as a De Laval nozzle (C-D nozzle) or a cold gas or liquid stream or solid-state quenching.

Furthermore, the embodiments described herein provide in another aspect a process for manufacturing lithium-ion batteries using the so-produced nano-Silicon-carbon composite.

Furthermore, the embodiments described herein provide in another aspect a method for manufacturing nano-Silicon-carbon coated composite.

Furthermore, the embodiments described herein provide in another aspect a process for use in producing pure nano-Silicon or nano-Silicon-carbon coated composites, comprising:
a) using one or more DC transferred arc for melting and vaporizing silicon; and
b) quenching the silicon vapour to form at least one of nano particles and nano wires.

Furthermore, the embodiments described herein provide in another aspect a process, wherein a reactor is provided, the reactor including the arc, an electrode and a crucible.

Furthermore, the embodiments described herein provide in another aspect a process, wherein the reactor is under vacuum.

Furthermore, the embodiments described herein provide in another aspect a process, wherein gas is injected in the reactor for quenching the silicon vapour.

Furthermore, the embodiments described herein provide in another aspect a process, wherein the gas is injected by a vortex.

Furthermore, the embodiments described herein provide in another aspect a process, wherein the electrode is hollow and the gas is injected via the electrode.

Furthermore, the embodiments described herein provide in another aspect a process, wherein the electrode is consumable and movable to control an arc voltage and to compensate for electrode erosion.

Furthermore, the embodiments described herein provide in another aspect a process, wherein a quenching gas used for quenching the silicon vapour includes an inert gas, such as argon.

Furthermore, the embodiments described herein provide in another aspect a process, wherein a quenching mixture used for quenching the silicon vapour includes an inert gas and carbon containing precursors such as hydrocarbons, so as to introduce hydrocarbons in a vaporization zone.

Furthermore, the embodiments described herein provide in another aspect a process, wherein quenching of the silicon vapour is effected internally of the reactor via at least one of a vortex and a hollow electrode.

Furthermore, the embodiments described herein provide in another aspect a process, wherein quenching of the silicon vapour is effected externally of the reactor, for instance using one of a De Laval nozzle (C-D nozzle), a cold gas or liquid stream, and a solid-state quenching.

Furthermore, the embodiments described herein provide in another aspect a process, wherein quenched particles are filtered, for instance with candle filter(s), then collected in a sealed collector and the collected powder is thereafter transferred, for instance, to a glove box having a controlled inert atmosphere to avoid oxidation.

Furthermore, the embodiments described herein provide in another aspect a process, wherein raw Silicon is provided in a batch or via a continuous feed.

Furthermore, the embodiments described herein provide in another aspect a process, wherein raw Silicon is first melted by an arc between the electrode and a bottom of a crucible of the reactor, a melted silicon acting as an anode and then being vaporized by an arc formed between the electrode and the anode.

Furthermore, the embodiments described herein provide in another aspect a process, wherein raw Silicon is first melted by an induction coil, a melted silicon acting as an anode and then being vaporized by an arc formed between the electrode and the anode.

Furthermore, the embodiments described herein provide in another aspect a process, wherein the induction coil is provided in walls of the reactor.

Furthermore, the embodiments described herein provide in another aspect a process, wherein the induction coil is adapted to directly preheat and melt the raw Silicon, with the vaporization of the melted silicon being achieved primarily by the arc.

Furthermore, the embodiments described herein provide in another aspect a process, wherein the induction coil is adapted to indirectly preheat and melt the raw Silicon by induction heating of a crucible, with the vaporization of the melted silicon being achieved primarily by the arc.

Furthermore, the embodiments described herein provide in another aspect a process, wherein a quenching rate is adapted to be adjusted by a number and diameter of holes defined in the vortex and the gas flow rate, and also for instance by selecting a quenching gas-entering angle.

Furthermore, the embodiments described herein provide in another aspect a process for manufacturing lithium-ion batteries using nano-Silicon-carbon composite produced by any one of the above processes.

Furthermore, the embodiments described herein provide in another aspect an apparatus for use in producing pure nano-Silicon or nano-Silicon-carbon coated composites, comprising:
a) a reactor including at least one electrode and adapted to provide at least one arc, e.g. a DC transferred arc, for melting and vaporizing silicon provided in the reactor; and
b) a quenching system for quenching a so-produced silicon vapour so as to form at least one of nano particles and nano wires.

Furthermore, the embodiments described herein provide in another aspect an apparatus, wherein the reactor includes a crucible.

Furthermore, the embodiments described herein provide in another aspect an apparatus, wherein the reactor is under vacuum, for instance via a vacuum pump.

Furthermore, the embodiments described herein provide in another aspect an apparatus, wherein a gas injector is provided for injecting a quenching gas in the reactor for quenching the silicon vapour.

Furthermore, the embodiments described herein provide in another aspect an apparatus, wherein the quenching gas is injected by a vortex.

Furthermore, the embodiments described herein provide in another aspect an apparatus, wherein the electrode is hollow and the gas injector includes the hollow electrode for injecting the quenching gas in a chamber of the reactor via the hollow electrode.

Furthermore, the embodiments described herein provide in another aspect an apparatus, wherein the electrode is consumable and movable, typically vertically, to control an arc voltage and to compensate for electrode erosion.

Furthermore, the embodiments described herein provide in another aspect an apparatus, wherein the quenching gas used for quenching the silicon vapour includes an inert gas, such as argon.

Furthermore, the embodiments described herein provide in another aspect an apparatus, wherein a quenching mixture used for quenching the silicon vapour includes an inert gas and carbon containing precursors such as hydrocarbons, so as to introduce hydrocarbons in a vaporization zone of the reactor.

Furthermore, the embodiments described herein provide in another aspect an apparatus, wherein the quenching system is provided internally of the reactor and includes at least one of a vortex and a hollow electrode for quenching of the silicon vapour.

Furthermore, the embodiments described herein provide in another aspect an apparatus, wherein the quenching system is provided externally of the reactor and includes, for instance, one of a De Laval nozzle (C-D nozzle), a cold gas or liquid stream, and a solid-state quenching.

Furthermore, the embodiments described herein provide in another aspect an apparatus, wherein a filtration system is provided externally of the reactor and is adapted to filter quenched particles, the filtration system including, for instance, candle filter(s).

Furthermore, the embodiments described herein provide in another aspect an apparatus, wherein a collector is provided externally of the reactor and is adapted to collect filtered particles.

Furthermore, the embodiments described herein provide in another aspect an apparatus, wherein a glove box is provided downstream of the collector and is adapted to contain the powder received from the collector, the glove box having a controlled inert atmosphere to avoid oxidation of the powder.

Furthermore, the embodiments described herein provide in another aspect an apparatus, wherein the reactor includes a feed entry for feeding, typically in a continuous manner, raw Silicon to a reactor chamber.

Furthermore, the embodiments described herein provide in another aspect an apparatus, wherein the reactor includes a crucible, and an initial arc is adapted to be provided between the electrode and a bottom of the crucible for melting raw Silicon provided in the reactor, a so melted silicon being then adapted to act as an anode and to be vaporized by the arc formed between the electrode and the anode.

Furthermore, the embodiments described herein provide in another aspect an apparatus, wherein the reactor includes an induction coil adapted to melt raw Silicon provided in the reactor, a so melted silicon being then adapted to act as an anode and to be vaporized by the arc formed between the electrode and the anode.

Furthermore, the embodiments described herein provide in another aspect an apparatus, wherein the induction coil is provided in walls of the reactor.

Furthermore, the embodiments described herein provide in another aspect an apparatus, wherein the induction coil is adapted to directly preheat and melt the raw Silicon, with a vaporization of the so melted silicon being achieved primarily by the arc.

Furthermore, the embodiments described herein provide in another aspect an apparatus, wherein the induction coil is adapted to indirectly preheat and melt the raw Silicon by induction heating of a crucible of the reactor, with a vaporization of the so melted silicon being achieved primarily by the arc.

Furthermore, the embodiments described herein provide in another aspect an apparatus, wherein holes are defined in the vortex, a number and diameter of the holes being selected for adjusting a quenching rate.

Furthermore, the embodiments described herein provide in another aspect an apparatus, wherein the quenching system is adapted to provide a selected quenching gas-entering angle.

Furthermore, the embodiments described herein provide in another aspect an apparatus, wherein the quenching system is adapted to adjust a flow rate of the quenching gas.

Furthermore, the embodiments described herein provide in another aspect an apparatus, wherein an extension projects externally from a crucible of the reactor to connect the crucible to a power supply.

Furthermore, the embodiments described herein provide in another aspect an apparatus, wherein the electrode is provided above a bottom of the reactor, raw silicon being adapted to be provided on the bottom of the reactor, the quenching system being adapted to supply quenching gas between the raw silicon and a lower end of the electrode, wherein the arc is provided between the electrode acting as a cathode and a melted raw Silicon acting as an anode.

Furthermore, the embodiments described herein provide in another aspect an apparatus, wherein an inlet is provided at an upper end of the reactor for feeding raw Silicon thereto, and wherein an outlet is provided at an upper end of the reactor for withdrawing quenched particles from the reactor.

Furthermore, the embodiments described herein provide in another aspect an apparatus, wherein the outlet communicates downstream thereof with a filtration unit adapted to filter the quenched particles.

Furthermore, the embodiments described herein provide in another aspect an apparatus for manufacturing lithium-ion batteries using nano-Silicon-carbon composite produced by any one of the above apparatuses.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 shows a Scanning Electron Microscopy (SEM) image of nano-Silicon particles produced in accordance with an exemplary embodiment;

FIG. 2 shows a SEM image of nano-Silicon wire and particles produced by SEM, in accordance with an exemplary embodiment;

FIG. 3 is an exemplary schematic representation of the process steps of nano-Silicon and/or nano-Silicon-carbon composite production, in accordance with an exemplary embodiment;

FIG. 4 is a schematic vertical cross-sectional view of a reactor in accordance with an exemplary embodiment;

FIG. 5 is a schematic bottom plan view of a vortex, of the reactor of FIG. 4, used for quenching gas (or any type of inert gas or mixture of inert gas and hydrocarbon), in accordance with an exemplary embodiment;

FIG. 6 is a schematic vertical cross-sectional view of a reactor including a preheating system using an induction coil, in accordance with an exemplary embodiment;

FIG. 7 is a schematic vertical cross-sectional view of a reactor including a quenching gas injection (hydrocarbon injection) through a hollow graphite electrode, in accordance with an exemplary embodiment; and

FIG. 8 is a schematic vertical cross-sectional view of a reactor including a quenching gas injection (hydrocarbon injection) through a hollow graphite electrode and a vortex, in accordance with an exemplary embodiment.

### DESCRIPTION OF VARIOUS EMBODIMENTS

The present subject matter relates to a process that uses pure silicon as raw material with no other pre-processed material. The arc process is proven to be scalable, knowing that the calculated specific vaporization energy of silicon is about 5 kWhr/kg which lies within the energy requirement of many different arc processes (for instance silicon smelting requires 11-13 kWhr/kg of silicon [18] compared to Siemens process 100 kWh/kg [Reference 19]).

The present subject matter discloses a process for producing nano-Silicon and/or nano-Silicon-carbon coated composite material in the form of particles, nanowires or a combination of both under 1 µm, preferably <300 nm, and most preferably <150 nm, to be used in high capacity and high energy efficiency manufacturing of anodes for Lithium-ion batteries. More specifically, the methods are herein provided for spherical nano-Silicon powder and nano-wire production with or without a specific carbon layer thickness and carbon concentration by adjusting carbon precursor type and the concentration in the gas mixture.

Accordingly, the present subject matter provides embodiments for the nano-Silicon and/or nano-Silicon-carbon composite powder production, which use a direct current transferred electric arc furnace similar to the one described in in International Patent Publication No. WO 2019/071335 A1 [Reference 20], published on Apr. 18, 2019 to Pyrogenesis Canada Inc., but with some key differences. In the present embodiments, the reactor is under vacuum and a vortex, as the quenching gas injector, is added to the reactor to introduce hydrocarbon (carbon precursor) in the vaporization zone. The hydrocarbon precursor injection can also be done with a hollow graphite electrode for the same objective. The purpose of using a hollow electrode is mainly to introduce gas for a few reasons: to enhance the vaporization rate by stabilizing the arc and reducing vaporization activation energy or sputtering, to introduce carbon atoms by decomposition of hydrocarbon in the hot zone, and to generate a plasma for supersaturation of gas by silicon atoms for effective nucleation process towards nano-Silicon or nano-Silicon-carbon composite production.

The reactor is equipped with one consumable electrode as cathode, although more electrodes can also be used to increase the vaporization and production rate. The electrode(s) is vertically movable in order to control the arc voltage and to compensate for electrode erosion. Once the raw silicon is melted, it acts as the anode and the arc that is transferred to the silicon anode effectively vaporizes it. In this process, the electric arc is used to create a supersaturated vapour from silicon followed by a high quench rate to initiate nucleation and coagulation of silicon atoms to form nano-Silicon particles.

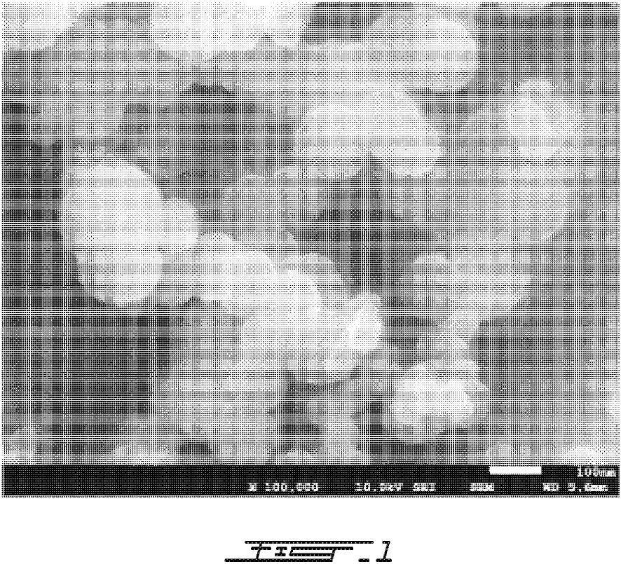

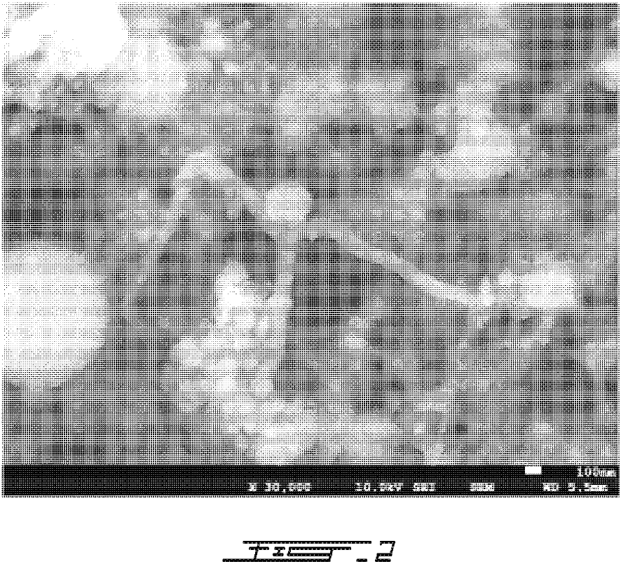

The process is not limited to the production of nano-Silicon particles and depending on the gas velocity and reactor pressure, nano-Silicon wires and/or nano-Silicon-wire-carbon coated composites can also be produced (see FIGS. 1 and 2).

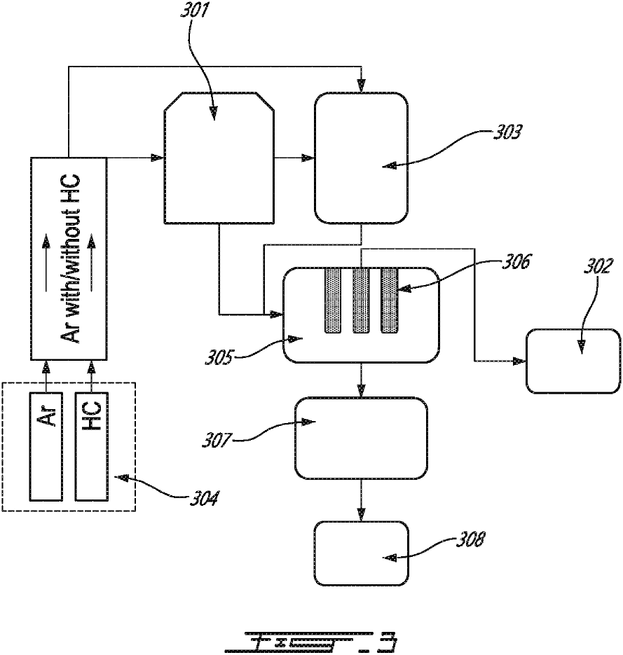

FIG. 3 summarizes the process steps to produce nano-Silicon and/or nano-Silicon-carbon composites. Silicon pieces, or preferably in the form of powder, as raw material can be fed continuously as a continuous process or pre-loaded in a reactor 301 as batch process. Once the silicon is melted and vaporized in the reactor 301, a vacuum pump 302 transfers the vapour to a quench system 303 in which a quenching gas 304 (inert gas only such as argon or mixture of inert gas and carbon containing precursors such as hydrocarbons) quenches the vapour. The vacuum pump 302 is used to maintain negative pressure in the reactor 301 and to regulate the reactor pressure in order to control the powder characteristics (D₅₀ and powder particle size distribution (PSD)) and vaporization temperature (the lower the pressure, the lower the vaporization temperature is) and to minimize the oxygen level.

The inert gas is used to prevent the oxidation of the nanoparticles and to control the silicon vaporization and quench rate. The inert gas as the quenching gas is used to produce nano-Silicon in which no carbon coating is needed. The quenched particles are transferred to a filtration chamber 305 and are deposited on an appropriate filtration medium, such as candle filter(s) 306, and then the particles are collected in a sealed collector 307. The final step is to transfer the collected powder to a glove box 308 with a controlled inert atmosphere to avoid nano-Silicon powder oxidation.

As described in following embodiment examples, the quench system can be integrated directly into the reactor, i.e. internal quenching, for a higher quench rate in which the quenching gas impacts instantly the silicon vapour in the vaporization zone. For internal quenching, the present subject matter provides the operational configurations for producing nanoparticles.

For external quenching, the quench can take place by means of a De Laval nozzle (C-D nozzle) or a cold gas or liquid stream or solid-state quenching. In either case, the powder is filtered by a candle filter and collected in the powder collector.

The following embodiment examples can be used for nano-Silicon-carbon coated composite production in which there are provided configurations and methods of hydrocarbon injection (as the carbon precursor) into the system to initiate the dissolution of carbon into the silicon particles. The hydrocarbon injection can be done also by a combination of the two above-mentioned configurations. Either reactor configurations can be used for pure nano-Silicon production as well as without hydrocarbon injection.

### Example 1

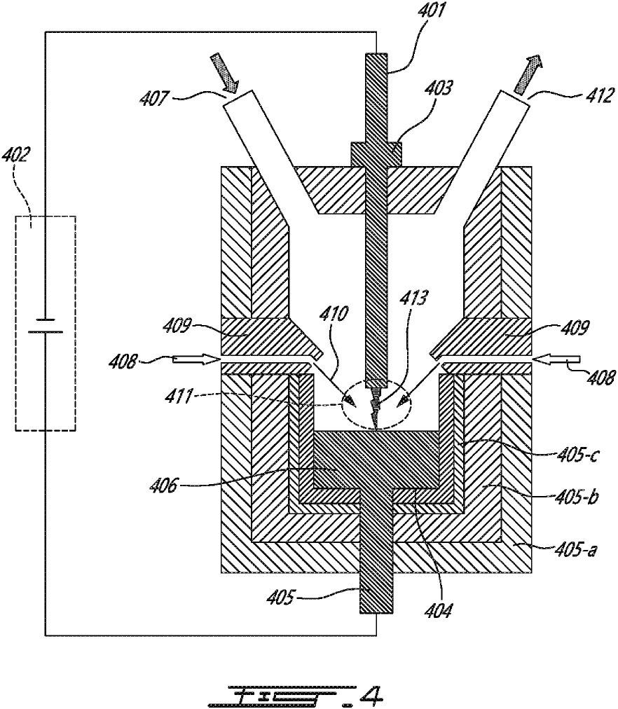

FIG. 4 represents the main part of the process, which is the reactor. The reactor used herein is a modified version of the vacuum arc furnace described in International Patent Publication No. WO 2019/071335 A1 [Reference 20]. In the present reactor, a gas injector is added to transfer high velocity inert gas or a mixture of inert gas and carbon precursor to the region close to the arc. The reactor used in this embodiment comprises a consumable graphite electrode 401, or made of other materials, as the cathode connected to a power supply 402, and connected to the reactor by an electrode sealant 403. A graphite crucible 404 is connected to the power supply 402 by an extension 405 and is insulated by layers of refractories material 405-a, 405-b and 405-c to operate the reactor at high enough temperatures for the melting and subsequent vaporization of silicon.

For a batch process, a raw silicon 406 can be pre-loaded in the crucible 404, or can preferably be fed continuously through a feed entry 407 to operate continuously. The arc is initially ignited between the cathode 401 and the bottom of the crucible 404 to preheat and melt the load 406 and then the arc 413 is transferred to the molten silicon to effectively vaporize silicon. The pure hydrocarbon as the carbon precursor or in a diluted form by an inert gas such as argon (or any sort of inert gas), used as the quenching agent, is injected at 408 by a vortex 409 and enters at 410 a vaporization/quenching/nucleation zone 411 at a specific angle and specific velocity. The silicon vaporization, quenching and nucleation process preferably takes place in the region around the arc 413. The hydrocarbon can be either ethane (C₂H₆), ethylene (CH₂), methane (CH₄), propane (C₃H₈) or any other hydrocarbon in any form of HₓC_{y}.

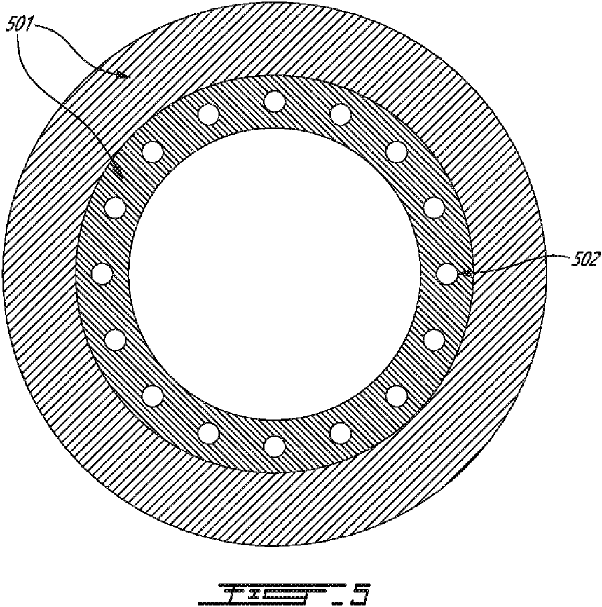

The powder and gas are transferred through an exit 412 to the filtration chamber 305 of FIG. 3. The quenching rate can be adjusted by the number and diameter of holes 502 of the vortex 501 shown in FIG. 5, and the gas flow rate 408 in FIG. 4. More specifically, choosing the quenching gas-entering angle, and the number and diameter of the vortex holes depends on the desired quenching gas rate. The type of inert gas can also affect the quenching rate.

### Example 2

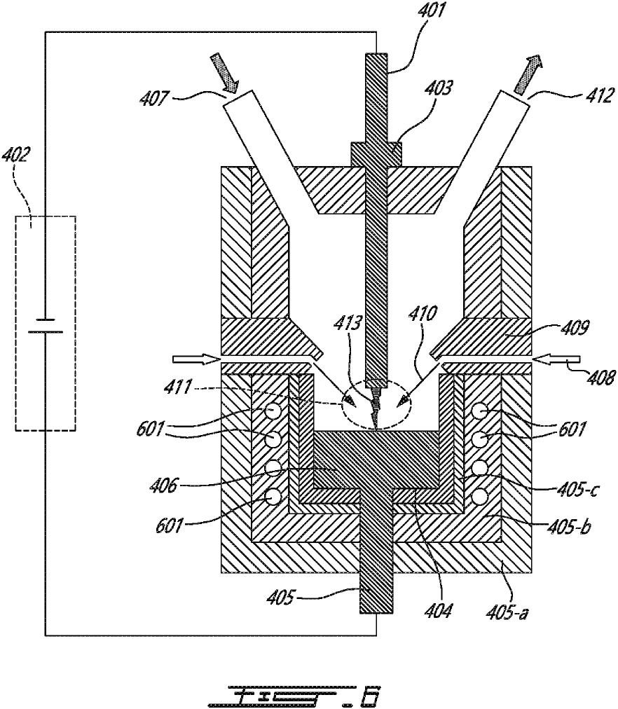

Alternatively, in a second embodiment, the silicon preheating/melting process can be obtained by an induction coil 601, as shown in FIG. 6. In this case, the silicon vaporization is realized primarily by the arc.

### Example 3

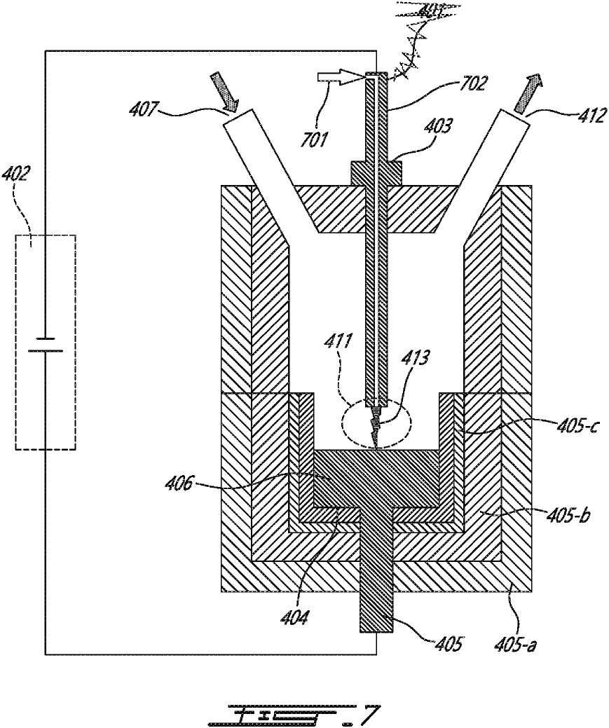

A third embodiment as another example is presented in FIG. 7, wherein a quenching gas 701 can be introduced into the vaporization/quenching/nucleation zone 411 of FIG. 4 via a hollow graphite electrode 702 (or made of other materials), without using the vortex 409 of FIGS. 4 and 6. Therefore, the quenching gas (argon, or any sort of inert gas or mixture of inert gas and hydrocarbon) enters the vaporization/quenching/nucleation zone 411 directly towards the arc direction.

### Example 4

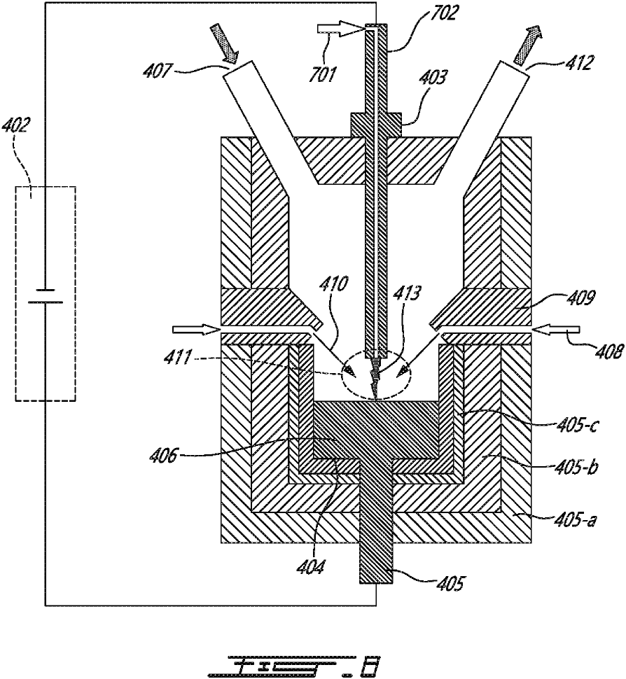

In fourth embodiment as a further example, the process of vaporization/quenching/nucleation can be realized in the configuration shown in FIG. 8 by introducing the quenching gas (argon or any sort of inert gas or mixture of inert gas and hydrocarbon) through both the vortex 409 (of FIGS. 4 and 6) and the hollow electrode 702 (of FIG. 7). In this embodiment, the quenching gas (argon or any sort of inert gas or mixture of inert gas and hydrocarbon) 701 can be introduced into the vaporization/quenching/nucleation zone 411 in FIG. 4 by the hollow electrode 702 and the vortex 409. This configuration results in a higher quenching rate, and more specifically if using hydrocarbon, higher carbon dissolution in silicon particles.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

### REFERENCES

Y. Fan, Q. Zhang, Q. Xiao, X. Wang, K. Huang, High performance lithium ion battery anodes based on carbon nanotube-silicon core-shell nanowires with controlled morphology, Carbon. 59 (2013) 264-269. doi:10.1016/j.carbon.2013.03.017.

P. Li, G. Zhao, X. Zheng, X. Xu, C. Yao, W. Sun, S.X. Dou, Recent progress on silicon-based anode materials for practical lithium-ion battery applications, Energy Storage Materials. 15 (2018) 422-446. doi:10.1016/j.ensm.2018.07.014.

Z.-L. Xu, X. Liu, Y. Luo, L. Zhou, J.-K. Kim, Nanosilicon anodes for high performance rechargeable batteries, Progress in Materials Science. 90 (2017) 1-44. doi:10.1016/j.pmatsci.2017.07.003.

C.K. Chan, H. Peng, G. Liu, K. McIIwrath, X.F. Zhang, R.A. Huggins, Y. Cui, High-Performance Lithium Battery Anodes Using Silicon Nanowires, Nature Nanotechnology. 3 (2007) 31. doi:10.1038/nnano.2007.411.

J.Y. Huang, L. Zhong, C.M. Wang, J.P. Sullivan, W. Xu, L.Q. Zhang, S.X. Mao, N.S. Hudak, X.H. Liu, A. Subramanian, H. Fan, L. Qi, A. Kushima, J. Li, In Situ Observation of the Electrochemical Lithiation of a Single SnO2 Nanowire Electrode, Science. 330 (2010) 1515. doi:10.1126/science.1195628.

X.H. Liu, L. Zhong, S. Huang, S.X. Mao, T. Zhu, J.Y. Huang, Size-Dependent Fracture of Silicon Nanoparticles During Lithiation, ACS Nano. 6 (2012) 1522-1531. doi:10.1021/nn204476h.

D.S.M. laboni, M.N. Obrovac, Li15Si4 Formation in Silicon Thin Film Negative Electrodes, Journal of The Electrochemical Society. 163 (2016) A255-A261. doi:10.1149/2.0551602jes.

J. Yang, X. Feng, J. Zhang, L. Zhou, Mesoporous silicon/carbon composite for use as lithium ion battery anode material and process of preparing the same, WO2013078645A1, n.d. https://patents.google.com/patent/US9379381B2/en.

J. Lyubina, Silicon-carbon composite powder, US20190016601A1, n.d. https://patents.google.com/patent/US20190016601A1/en?oq=Silicon-carbon+composite+powder+2019%2f0016601.

S. Zhao, Y. Xu, X. Xian, N. Liu, W. Li, Fabrication of Porous Si@C Composites with Core-Shell Structure and Their Electrochemical Performance for Li-ion Batteries, Batteries. 5 (2019) 27. doi:10.3390/batteries5010027.

Y. Liu, K. Hanai, J. Yang, N. Imanishi, A. Hirano, Y. Takeda, Silicon/Carbon Composites as Anode Materials for Li-lon Batteries, Electrochem. Solid-State Lett. 7 (2004) A369-A372. doi:10.1149/1.1795031.

Y.M. Lee, J.Y. Lee, H.-T. Shim, J.K. Lee, J.-K. Park, SEI Layer Formation on Amorphous Si Thin Electrode during Precycling, J. Electrochem. Soc. 154 (2007) A515. doi:10.1149/1.2719644.

M. Yoshio, T. Tsumura, N. Dimov, Electrochemical behaviors of silicon based anode material, Journal of Power Sources. 146 (2005) 10-14. doi:10.1016/j.jpowsour.2005.03.143.

M.T. McDowell, I. Ryu, S.W. Lee, C. Wang, W.D. Nix, Y. Cui, Studying the Kinetics of Crystalline Silicon Nanoparticle Lithiation with In Situ Transmission Electron Microscopy, Advanced Materials. 24 (2012) 6034-6041. doi:10.1002/adma.201202744.

I. Ryu, J.W. Choi, Y. Cui, W.D. Nix, Size-dependent fracture of Si nanowire battery anodes, Journal of the Mechanics and Physics of Solids. 59 (2011) 1717-1730. doi:10.1016/j.jmps.2011.06.003.

J. Lyubina, B. Frings, A. Höfler, R. Störger, S. Bade, Evonik, Industrial-Scale synthesis of high performance S-based nanopowders for energy storage applications, in: Silicon for Chemical and Solar Industry XIV, Svolvær, Norway, 2018.

R. Lv, J. Yang, P. Gao, Y. NuLi, J. Wang, Electrochemical behavior of nanoporous/nanofibrous Si anode materials prepared by mechanochemical reduction, Journal of Alloys and Compounds. 490 (2010) 84-87. doi:10.1016/j.jallcom.2009.10.023.

M. Tangstad, B.S. Xakalashe, Silicon processing: from quartz to crystalline silicon solar cells, in: Southern African Pyrometallurgy 2011, Johannesburg, 2011.

A.F.B. Braga, S.P. Moreira, P.R. Zampieri, J.M.G. Bacchin, P.R. Mei, New processes for the production of solar-grade polycrystalline silicon: a review, Solar Energy Materials and Solar Cells. 92 (2008) 418-424. doi:10.1016/j.solmat.2007.10.003.

P. Carabin, W. Kreklewetz, A. Shahverdi, H. Fortin-Blanchette, DC arc furnace for waste melting and gasification, WO2019071335A1, n.d. https://patents.google.com/patent/WO2019071335A1/en?q=Dc&q=arc+furnace &q=waste&q=melting&q=gasification.

1. A process for use in producing pure nano-Silicon or nano-Silicon-carbon coated composites, comprising:
a) using one or more DC transferred arc for melting and vaporizing silicon; and
b) quenching the silicon vapour to form at least one of nano particles and nano wires.

2. The process of claim 1, wherein a reactor is provided, the reactor including the arc, an electrode and a crucible.

3. The process of claim 2, wherein the reactor is under vacuum.

4. The process of any one of claims 2 to 3, wherein gas is injected in the reactor for quenching the silicon vapour.

5. The process of claim 4, wherein the gas is injected by a vortex.

6. The process of claim 4, wherein the electrode is hollow and the gas is injected via the electrode.

7. The process of any one of claims 1 to 6, wherein the electrode is consumable and movable to control an arc voltage and to compensate for electrode erosion.

8. The process of any one of claims 1 to 7, wherein a quenching gas used for quenching the silicon vapour includes an inert gas, such as argon.

9. The process of any one of claims 1 to 7, wherein a quenching mixture used for quenching the silicon vapour includes an inert gas and carbon containing precursors such as hydrocarbons, so as to introduce hydrocarbons in a vaporization zone.

10. The process of any one of claims 1 to 4, wherein quenching of the silicon vapour is effected internally of the reactor via at least one of a vortex and a hollow electrode.

11. The process of any one of claims 1 to 4, wherein quenching of the silicon vapour is effected externally of the reactor, for instance using one of a De Laval nozzle (C-D nozzle), a cold gas or liquid stream, and a solid-state quenching.

12. The process of any one of claims 1 to 11, wherein quenched particles are filtered, for instance with candle filter(s), then collected in a sealed collector and the collected powder is thereafter transferred, for instance, to a glove box having a controlled inert atmosphere to avoid oxidation.

13. The process of any one of claims 1 to 12, wherein raw Silicon is provided in a batch or via a continuous feed.

14. The process of any one of claims 2 to 13, wherein raw Silicon is first melted by an arc between the electrode and a bottom of a crucible of the reactor, a melted silicon acting as an anode and then being vaporized by an arc formed between the electrode and the anode.

15. The process of any one of claims 2 to 13, wherein raw Silicon is first melted by an induction coil, a melted silicon acting as an anode and then being vaporized by an arc formed between the electrode and the anode.

16. The process of claim 15, wherein the induction coil is provided in walls of the reactor.

17. The process of claim 15, wherein the induction coil is adapted to directly preheat and melt the raw Silicon, with the vaporization of the melted silicon being achieved primarily by the arc.

18. The process of claim 15, wherein the induction coil is adapted to indirectly preheat and melt the raw Silicon by induction heating of a crucible, with the vaporization of the melted silicon being achieved primarily by the arc.

19. The process of any one of claims 5 and 10, wherein a quenching rate is adapted to be adjusted by a number and diameter of holes defined in the vortex and the gas flow rate, and also for instance by selecting a quenching gas-entering angle.

20. A process for manufacturing lithium-ion batteries using nano-Silicon-carbon composite produced by the process of any one of claims 1 to 19.

21. An apparatus for use in producing pure nano-Silicon or nano-Silicon-carbon coated composites, comprising:
a) a reactor including at least one electrode and adapted to provide at least one arc, e.g. a DC transferred arc, for melting and vaporizing silicon provided in the reactor; and
b) a quenching system for quenching a so-produced silicon vapour so as to form at least one of nano particles and nano wires.

22. The apparatus of claim 21, wherein the reactor includes a crucible.

23. The apparatus of any one of claims 21 to 22, wherein the reactor is under vacuum, for instance via a vacuum pump.

24. The apparatus of any one of claims 21 to 23, wherein a gas injector is provided for injecting a quenching gas in the reactor for quenching the silicon vapour.

25. The apparatus of claim 24, wherein the quenching gas is injected by a vortex.

26. The apparatus of claim 24, wherein the electrode is hollow and the gas injector includes the hollow electrode for injecting the quenching gas in a chamber of the reactor via the hollow electrode.

27. The apparatus of any one of claims 21 to 26, wherein the electrode is consumable and movable, typically vertically, to control an arc voltage and to compensate for electrode erosion.

28. The apparatus of any one of claims 24 to 27, wherein the quenching gas used for quenching the silicon vapour includes an inert gas, such as argon.

29. The apparatus of any one of claims 21 to 27, wherein a quenching mixture used for quenching the silicon vapour includes an inert gas and carbon containing precursors such as hydrocarbons, so as to introduce hydrocarbons in a vaporization zone of the reactor.

30. The apparatus of any one of claims 21 to 24, wherein the quenching system is provided internally of the reactor and includes at least one of a vortex and a hollow electrode for quenching of the silicon vapour.

31. The apparatus of any one of claims 21 to 24, wherein the quenching system is provided externally of the reactor and includes, for instance, one of a De Laval nozzle (C-D nozzle), a cold gas or liquid stream, and a solid-state quenching.

32. The apparatus of any one of claims 21 to 31, wherein a filtration system is provided externally of the reactor and is adapted to filter quenched particles, the filtration system including, for instance, candle filter(s).

33. The apparatus of any one of claims 21 to 32, wherein a collector is provided externally of the reactor and is adapted to collect filtered particles.

34. The apparatus of claim 33, wherein a glove box is provided downstream of the collector and is adapted to contain the powder received from the collector, the glove box having a controlled inert atmosphere to avoid oxidation of the powder.

35. The apparatus of any one of claims 1 to 34, wherein the reactor includes a feed entry for feeding, typically in a continuous manner, raw Silicon to a reactor chamber.

36. The apparatus of any one of claims 21 to 35, wherein the reactor includes a crucible, and an initial arc is adapted to be provided between the electrode and a bottom of the crucible for melting raw Silicon provided in the reactor, a so melted silicon being then adapted to act as an anode and to be vaporized by the arc formed between the electrode and the anode.

37. The apparatus of any one of claims 21 to 35, wherein the reactor includes an induction coil adapted to melt raw Silicon provided in the reactor, a so melted silicon being then adapted to act as an anode and to be vaporized by the arc formed between the electrode and the anode.

38. The apparatus of claim 37, wherein the induction coil is provided in walls of the reactor.

39. The apparatus of claim 37, wherein the induction coil is adapted to directly preheat and melt the raw Silicon, with a vaporization of the so melted silicon being achieved primarily by the arc.

40. The apparatus of claim 37, wherein the induction coil is adapted to indirectly preheat and melt the raw Silicon by induction heating of a crucible of the reactor, with a vaporization of the so melted silicon being achieved primarily by the arc.

41. The apparatus of any one of claims 25 and 30, wherein holes are defined in the vortex, a number and diameter of the holes being selected for adjusting a quenching rate.

42. The apparatus of claim 41, wherein the quenching system is adapted to provide a selected quenching gas-entering angle.

43. The apparatus of any one of claims 21 to 42, wherein the quenching system is adapted to adjust a flow rate of the quenching gas.

44. The apparatus of any one of claims 21 to 43, wherein an extension projects externally from a crucible of the reactor to connect the crucible to a power supply.

45. The apparatus of any one of claims 21 to 44, wherein the electrode is provided above a bottom of the reactor, raw silicon being adapted to be provided on the bottom of the reactor, the quenching system being adapted to supply quenching gas between the raw silicon and a lower end of the electrode, wherein the arc is provided between the electrode acting as a cathode and a melted raw Silicon acting as an anode.

46. The apparatus of any one of claims 21 to 45, wherein an inlet is provided at an upper end of the reactor for feeding raw Silicon thereto, and wherein an outlet is provided at an upper end of the reactor for withdrawing quenched particles from the reactor.

47. The apparatus of claim 46, wherein the outlet communicates downstream thereof with a filtration unit adapted to filter the quenched particles.

48. An apparatus for manufacturing lithium-ion batteries using nano-Silicon-carbon composite produced by the apparatus of any one of claims 21 to 47.
